(19) United States
(12) Patent Application Publication
(10) Pub. No.: US 2005/0264000 A1
(43) Pub. Date: Dec. 1, 2005

(54) Apparatus for retaining and organizing printed material

(76) Inventor: David James Garland JR., Farmington, NY (US)

Correspondence Address: ROBERT D. GUNDERMAN, JR.;PATENT TECHNOLOGIES, LLC, 150 LUCIUS GORDON DRIVE, SUITE 205, WEST HENRIETTA, NY, 14586, US

(21) Appl. No.: 11/128,077

(22) Filed: May 12, 2005

Related U.S. Application Data
(60) Provisional application No. 60/575,685, filed on May 28, 2004.

(51) Int. Cl. B42D 3/00

(52) U.S. Cl. 281/45

(57) ABSTRACT

An apparatus for retaining and organizing printed material that includes a channel for receiving paper or printed material. The channel may include a flanged opening and off-centered members to better receive the paper or printed material. The apparatus may be fastened to a flat surface such as a bulletin board, tack board, or the like. The apparatus allows one to easily and safely add and remove papers from a bulletin board or tack board without piercing the paper by use of a tack or similar object. The apparatus further reduces clutter on a bulletin board or tack board by spatially organizing papers and printed materials on said bulletin board or tack board.

### CROSS-REFERENCE TO RELATED PATENT APPLICATIONS

This application claims the benefit of the filing date of U.S. Provisional patent application Serial No. U.S. Ser. No. 60/575,685 filed on May 28, 2004.

### BACKGROUND OF THE INVENTION

1. Field of the Invention

This invention relates generally to an apparatus for holding printed material on a surface, and more particularly to an apparatus for retaining and organizing printed material.

2. Description of the Prior Art

The prior art has disclosed various devices for securing printed material to a cork board, bulletin board, tack board, or other flat surface. Push pins, tacks, and staples are commonly used devices that have existed for many years. These devices are pushed through the printed material and into the cork board, bulletin board, tack board, or other flat surface. Tacks, push pins, and staples, when used in such a manner, pierce a hole through the printed material. While often times this is not objectionable, at times damaging the printed material with a pierced hole is not desirable. For example, it is usually undesirable to pierce holes through historic documents, photographs, valuable papers, and the like.

Bulletin boards, tack boards, and cork boards are commonly used in public places for advertising. It is common for such a board to contain numerous business cards and advertising flyers. When push pins, tacks, or staples are used on such a board, there is little or no ability to organize the printed material on the board. When an individual desires to add or remove printed material to the board, frequently the board is so cluttered with printed material that some items fall to the floor unintentionally. In addition, often times multiple printed articles are held in place with one push pin, tack or staple. This practice makes the insertion and removal of a tack, pushpin or staple physically difficult, and represents an enormous challenge to those with disabilities.

Pushpins, tacks and staples are sharp objects, and are not commonly used in applications that involve young children or disabled individuals. In these applications, tape is often times used. Tape is not always a preferred fastener, as it will frequently damage the paper or the surface that the paper is attached to. In addition, at times tape will not properly fasten the paper to a desired surface.

It is therefore an object of the present invention to provide a device that retains printed material without damaging the printed material. It is another object of the present invention to provide a device for retaining printed material that is easy to use and requires minimal hand strength or coordination. It is a further object of the present invention to provide a device that retains printed material that is safe for use by small children and the disabled. It is yet another object of the present invention to provide a device that organizes and neatly retains printed material.

### BRIEF SUMMARY OF THE INVENTION

An apparatus for retaining and organizing printed material comprising a channel having a first member and a second member whereas the width of said second member is less than the width of said first member and whereas said first member and said second member are elastically connected, a flanged edge connected to said second member, and a fastening means for attaching said apparatus to a surface.

The foregoing paragraph has been provided by way of introduction, and is not intended to limit the scope of the following claims.

### BRIEF DESCRIPTION OF THE DRAWINGS

The invention will be described by reference to the following drawings, in which like numerals refer to like elements, and in which:

FIG. 1 is a front plan view of an apparatus for retaining and organizing printed material;

FIG. 2 is a back plan view of an apparatus for retaining and organizing printed material;

FIG. 3 is a side elevation view of an apparatus for retaining and organizing printed material;

FIG. 4 is an end elevation view of an apparatus for retaining and organizing printed material;

FIG. 5 is a perspective view of an apparatus for retaining and organizing printed material;

FIG. 6 is a perspective view of two apparatuses for retaining and organizing printed material that are interconnected as a system;

FIG. 7 illustrates the use of an apparatus for retaining and organizing printed material; and

FIG. 8 is a plan view of a slip board.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENTS

For a general understanding of the present invention, reference is made to the drawings. In the drawings, like reference numerals have been used throughout to designate identical elements.

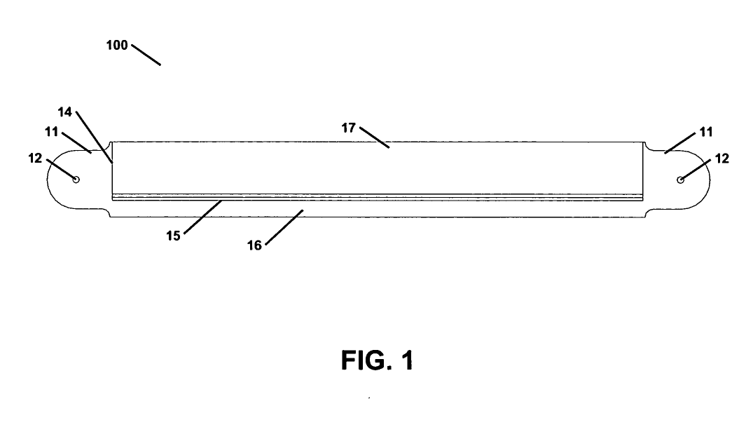

FIG. 1 is a front plan view of an apparatus 100 for retaining and organizing printed material. In one embodiment of the present invention, the apparatus 100 is rectangular in shape, and contains a channel 14. The channel 14 has a first member 16 and a second member 17 that, in some embodiments, are elastically connected together. The first member 16 and the second member 17 make contact, but can be separated by inserting paper or other printed matter into the channel 14. When paper or other printed matter is inserted into the channel 14, the elastic connection between the first member and the second member provides inward force that acts to draw the first member 16 and the second member 17 together, thus retaining paper or other printed material. In some embodiments of the present invention, the apparatus 100 is extruded from a rigid vinyl such as Geon 2188. The use of a rigid vinyl provides for a moderately stiff yet elastic structure that does not exhibit a memory effect. In plastics, a memory effect relates to a material property where a plastic, upon being deformed in some way, memorizes or retains the shape that the plastic was deformed to. When paper or printed material is inserted into the channel 14, it is undesirable for the channel 14 to deform while the paper or printed material is inserted into the channel 14, and not return to it's original dimensions when the paper or printed material is removed. In other embodiments of the present invention, the apparatus 100 may be made from another plastic such as polypropylene, or may be made from a metal such as brass, stainless steel, or the like. In other embodiments of the present invention, the apparatus 100 may be made from wood, fiberglass, or rubber.

In a preferred embodiment of the present invention, the first member 16 and the second member 17 are made from a single piece of material, and form a channel 14. In such an embodiment, the joining of the first member 16 and the second member 17 creates an elastic connection similar to a hinge.

In some embodiments of the present invention, the width of the second member 17 is less than the width of the first member 16, as can be clearly seen in FIG. 1. This asymmetric spacing makes it easier to insert paper or printed material into the channel 14.

In some embodiments of the present invention, a flanged edge 15 is connected to the second member 17 to make it easier to insert paper or printed material into the channel 14. The flanged edge 15 serves to guide paper or printed material into the channel 14. The flanged edge 15 may be more clearly seen in FIG. 4. In other embodiments of the present invention, the first member 16 is connected to a flanged edge 15.

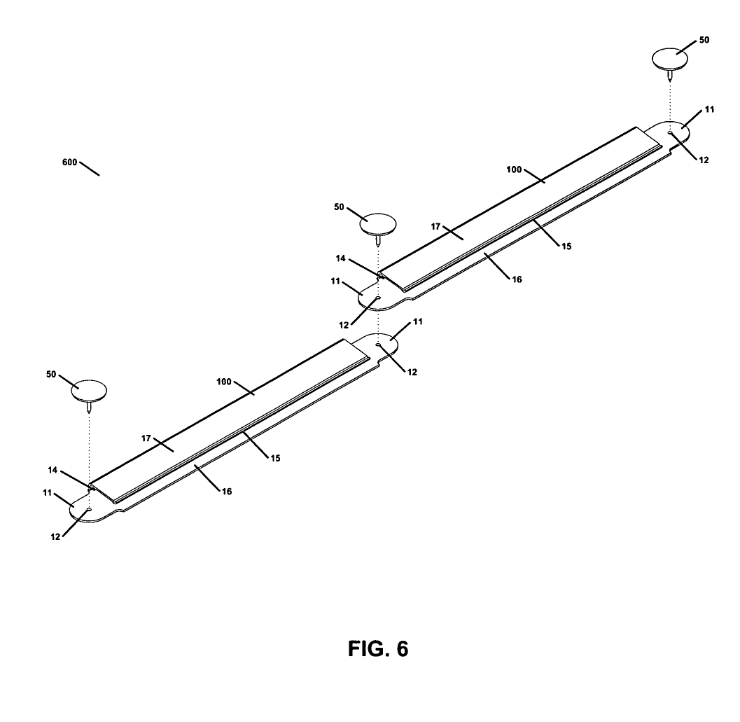

Referring again to FIG. 1, the apparatus 100 may, in some embodiments, contain a flat end 11 with a hole 12 to allow for mounting the apparatus 100 with a thumbtack, pushpin, or the like. The flat end 11 may also be used to interconnect multiple apparatuses 100, as will be more clearly seen later in FIG. 6.

The apparatus 100 may be manufactured in any length to suit the application. The apparatus 100, in a preferred embodiment, is extruded from a rigid vinyl or other plastic. Extrusion of plastics is well known to those skilled in the art. After extruding, the raw stock material is cut to a desired length. Once cut to the desired length, the flat ends 11 are formed by machining or cutting a portion of the second member 17 away on either end of the cut stock material. Once a portion of the second member 17 is removed on either end of the cut stock material, a punch is used to create a hole 12 and, in some embodiments, to round the corners of the flat end 11.

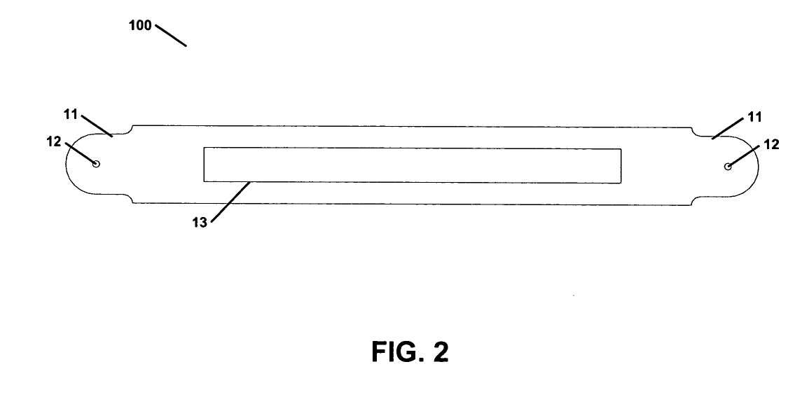

Referring now to FIG. 2, a back plan view of an apparatus 100 for retaining and organizing printed material is shown. The back of the apparatus 100 for retaining and organizing printed material may, in some embodiments, contain a retention strip 13. The retention strip 13 may, in some embodiments, be a magnet or a magnetic strip that allows for the mounting of the apparatus 100 on a magnetic surface without the use of thumbtacks, pushpins, or the like. In other embodiments of the present invention, the retention strip 13 may be an adhesive strip, a hook and loop fastener, or the like.

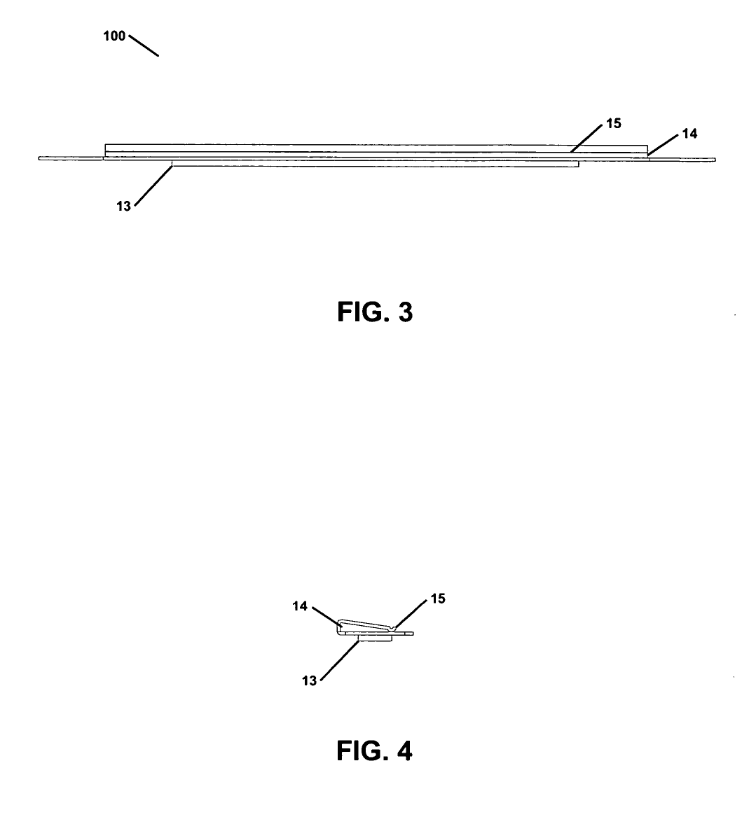

Referring now to FIG. 3, a side elevation view of an apparatus for retaining and organizing printed material 100 is shown.

FIG. 4 is an end elevation view of an apparatus for retaining and organizing printed material 100 that more clearly shows the flanged edge 15 that is used to guide paper or printed material into the channel 14. Also shown in FIG. 4 is the shape of the channel 14 according to one embodiment of the present invention, and the surfaces that contact paper or printed material, causing said paper or printed material to be retained by the apparatus 100.

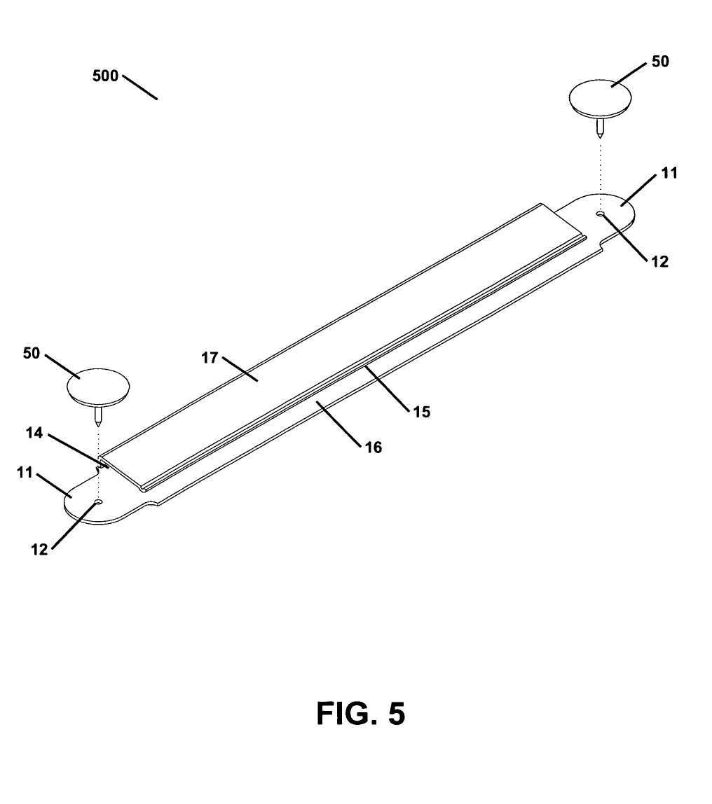

FIG. 5 is a perspective view of an apparatus for retaining and organizing printed material 100 that shows the use of thumb tacks 50 to retain said apparatus 100 to a bulletin board, cork board, or the like. The thumb tacks 50 are inserted through the holes 12 that are contained on each flat end 11.

Turning now to FIG. 6, a system for retaining and organizing printed material 600 is depicted. The system 600 includes at least two apparatuses 100 for retaining and organizing printed material that are interconnected end to end by overlapping the flat end 11 of adjacent apparatuses 100, and placing a thumbtack or pushpin 50 through adjacent holes 12, as is clearly shown in FIG. 6. The ability to interconnect multiple apparatuses 100 for retaining and organizing printed material allows one to create long paper retention structures that conform to a specific size bulletin board or a specific application.

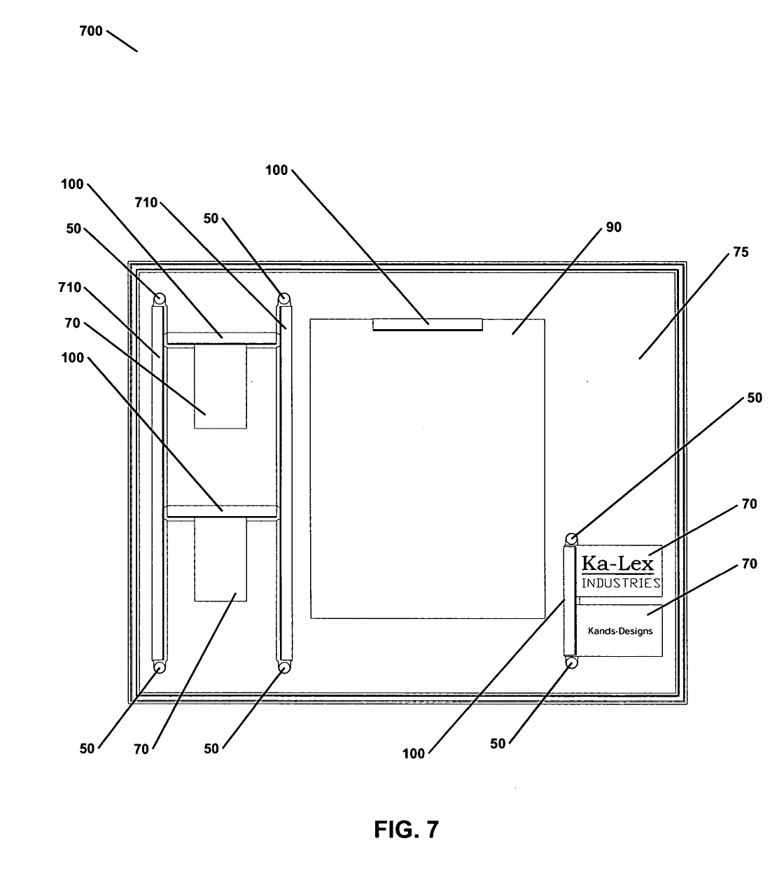

FIG. 7 illustrates the use of an apparatus 100 for retaining and organizing printed material 100 on a bulletin board 75. The apparatus 100 is securely held to the bulletin board 75 using tacks or pushpins 50. Also shown in FIG. 7 by way of example, and not limitation, is the organized retention of business cards 70 and paper 90 using the apparatus 100 mounted to a bulletin board 75. Also illustrated by way of FIG. 7 is a system for adjusting the position of an apparatus for retaining and organizing printed material. The system is depicted to the left side of FIG. 7 and includes two vertical rails 710 that are attached to a bulletin board 75 with tacks or pushpins 50. The vertical rail 710 is essentially an apparatus for retaining and organizing printed material 100 that is used to receive the flat end of a horizontally mounted apparatus 100 for retaining and organizing printed material. This system eliminates the need to remove and reinsert tacks or pushpins 50 when changing the vertical location of an apparatus 100 for retaining and organizing printed material.

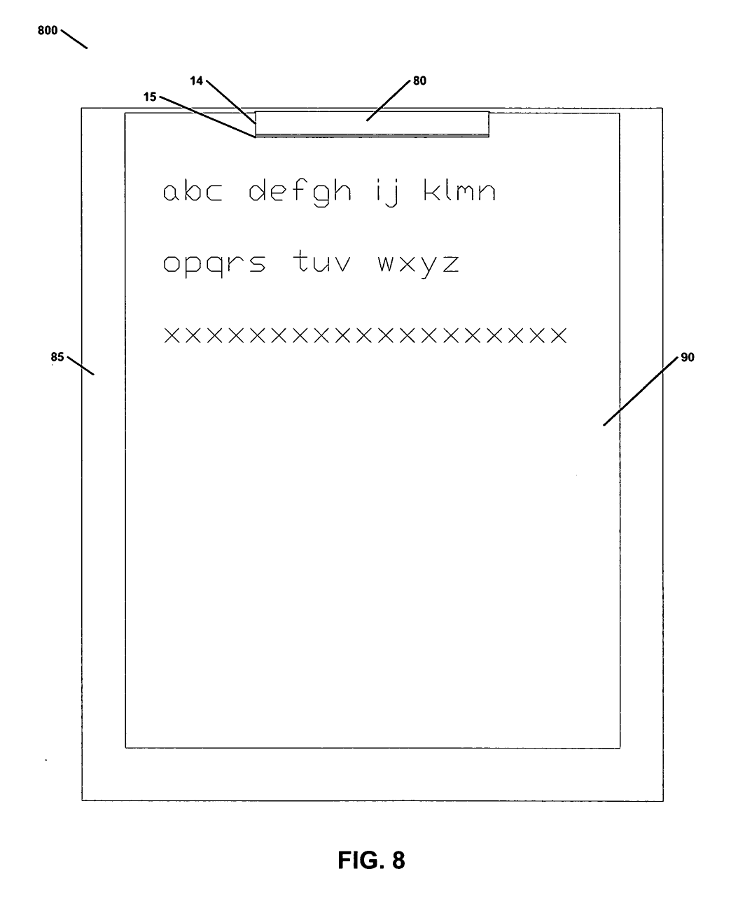

Lastly, FIG. 8 shows a slip board 800. A slip board 100 is similar to a common clip board. The slip board includes a printed material retainer 80 that is similar to the apparatus 100, is rectangular in shape, and contains a channel 14. The channel 14 has a first member 16 and a second member 17 that, in some embodiments, are elastically connected together. The first member 16 and the second member 17 make contact, but can be separated by inserting paper or other printed matter into the channel 14. When paper or other printed matter is inserted into the channel 14, the elastic connection between the first member and the second member provides inward force that acts to draw the first member 16 and the second member 17 together, thus retaining paper or other printed material. The use of the printed material retainer 80 is an improvement over a common clipboard in that paper can be inserted and removed from the printed material retainer 80 without the need for depressing a spring actuated lever, as is commonly used in clipboards. This improvement makes it easier for the disabled, small children, and the elderly to insert and remove paper. The slip board 100 further includes a writing surface 85 that is connected to the printed material retainer 80 using glue, screws, rivets, or the like. FIG. 8 shows papers 90 being held firmly in place on the slip board 800.

It is, therefore, apparent that there has been provided, in accordance with the various objects of the present invention, an apparatus for retaining and organizing printed material. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. An apparatus for retaining and organizing printed material, the apparatus comprising:
a channel having a first member and a second member, wherein said first member and said second member are elastically connected together;
a flanged edge connected to said second member; and
a fastening means for attaching said apparatus to a surface.

2. The apparatus as recited in claim 1 further comprising a flat end to allow for end to end connection of a plurality of said apparatuses.

3. The apparatus as recited in claim 1 wherein said apparatus is substantially made from rigid vinyl.

4. The apparatus as recited in claim 1 wherein said fastening means is a magnet.

5. The apparatus as recited in claim 1, wherein said fastening means is a hook and loop fastener.

6. The apparatus as recited in claim 1, wherein said fastening means is adhesive tape.

7. The apparatus as recited in claim 1, wherein said fastening means is a tack.

8. A bulletin board system comprising:
a plurality of apparatuses for retaining and organizing printed material, each apparatus comprised of a channel having a first member and a second member, wherein said first member and said second member are elastically connected together; a flanged edge connected to said second member, and a fastening means for attaching said apparatus to a board; and
a board containing said plurality of apparatuses wherein said apparatuses are attached to said board.

9. A clip board comprising:
an apparatus for retaining and organizing printed material, the apparatus comprised of a channel having a first member and a second member, wherein said first member and said second member are elastically connected together, and a flanged edge connected to said second member; and
a writing surface wherein said apparatus is mechanically attached to said writing surface along a perimeter of said writing surface.
